(19) United States
(12) Patent Application Publication
(10) Pub. No.: US 2006/0018505 A1
(43) Pub. Date: Jan. 26, 2006

(54) Method, system and software for enhanced data protection using raw device backup of copy-on-write snapshots

(75) Inventors: Jacob Cherian, Austin, TX (US); Richard K. Golasky, Georgetown, TX (US); Marc Padovani, Austin, TX (US)

Correspondence Address: BAKER BOTTS, LLP, 910 LOUISIANA, HOUSTON, TX, 77002-4995, US

(73) Assignee: Dell Products L.P., Round Rock, TX (US)

(21) Appl. No.: 10/896,715

(22) Filed: Jul. 22, 2004

(51) Int. Cl. G06K 9/00

(52) U.S. Cl. 382/100

(57) ABSTRACT

The present disclosure provides a method, system and software to backup a data volume containing snapshots using a block copy process and a raw data enabled device. In addition, the present disclosure provides a method, system and software for restoring snapshots to a snapshot volume that then allows system volume restoration to a selected point-in-time image.

### TECHNICAL FIELD

The present disclosure relates generally to information handling systems and, more particularly, to data management in information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Attempting to minimize backup windows, system administrators often prefer to backup data incrementally by backing-up only new or modified files. Current technology, such as “copy-on-write” snapshot backup utilities, is a preferred choice for data protection due to its speed, efficiency and ease of restoring a base or source volume to substantially any “point-in-time”. However, one problem with “copy-on-write” snapshot solutions is the inability of ordinary backup software applications to recognize the data structure of snapshots residing on a data volume. Due to the architecture of the snapshot's cache and pointer based system, it is generally not possible to successfully backup and restore, via an operating system's file system, the contents of a snapshot. Normally, backing up a snapshot via the file system will result in irrelevant data (pointers) being backed up, thus, resulting in invalid data when the snapshot is restored.

### SUMMARY

In accordance with teachings of the present disclosure, a method for providing enhanced data protection is provided. In an exemplary embodiment, the method preferably includes obtaining a first image of a data file, storing the first image of the data file in a first data storage area and storing data indicative of the first image in a second data storage area. The exemplary method preferably also includes obtaining one or more images of the data file subsequent to the first image in response to one or more monitored events. The exemplary method preferably further includes storing one or more of the subsequent images of the data file in the first data storage area and data indicative of one or more of the subsequent images of the data file in a second data storage area.

Further in accordance with teachings of the present disclosure, software for providing enhanced data backup is described. In an exemplary embodiment, the software is embodied in computer readable media. The software of an exemplary embodiment is preferably operable to copy, in an unprocessed data format, a first backup image of a data array residing in a first data storage area, the backup image residing in a second data storage area. The exemplary software is preferably also operable to store the copied first backup image in a third data storage area as unprocessed data. Further, the exemplary software is preferably operable to copy, in an unprocessed data format, one or more subsequent backup images created from the data array residing in the first data storage area, the subsequent backup images residing in the second data storage area. In addition, the exemplary software is preferably operable to store the one or more subsequent backup images as unprocessed data in the third data storage area.

In another aspect, teachings of the present disclosure describe an information handling system providing enhanced data backup and protection. An exemplary information handling system preferably includes memory, at least one processor operably coupled to the memory and a program of instructions storable in the memory and executable in the processor. In the exemplary information handling system, the program of instructions is preferably operable to perform copy-on-write snapshots of data residing on a first data storage device, store the snapshots on a snapshot data storage device and copy the snapshots as raw data to a raw data storage device.

In one aspect, teachings of the present disclosure provide a technical advantage in enabling the backup of existing copy-on-write and/or point-in-time snapshot volumes.

In another aspect, teachings of the present disclosure provide a technical advantage in the ability to further restore a system volume with granularity to substantially any point-in-time image.

In a further aspect, teachings of the present disclosure provide a technical advantage in the ability to resume backup operations from the point of failure or restoration.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a flow diagram depicting one embodiment of an exemplary method for enhanced data protection using raw device backup of copy-on-write snapshots according to teachings of the present disclosure;

FIG. 2 is a flow diagram depicting one embodiment of an exemplary method for restoring a failing or failed data volume according to teachings of the present disclosure; and

FIG. 3 is a schematic diagram depicting an exemplary embodiment of a system operable to perform raw device backup of copy-on-write snapshot images according to teachings of the present disclosure.

### DETAILED DESCRIPTION

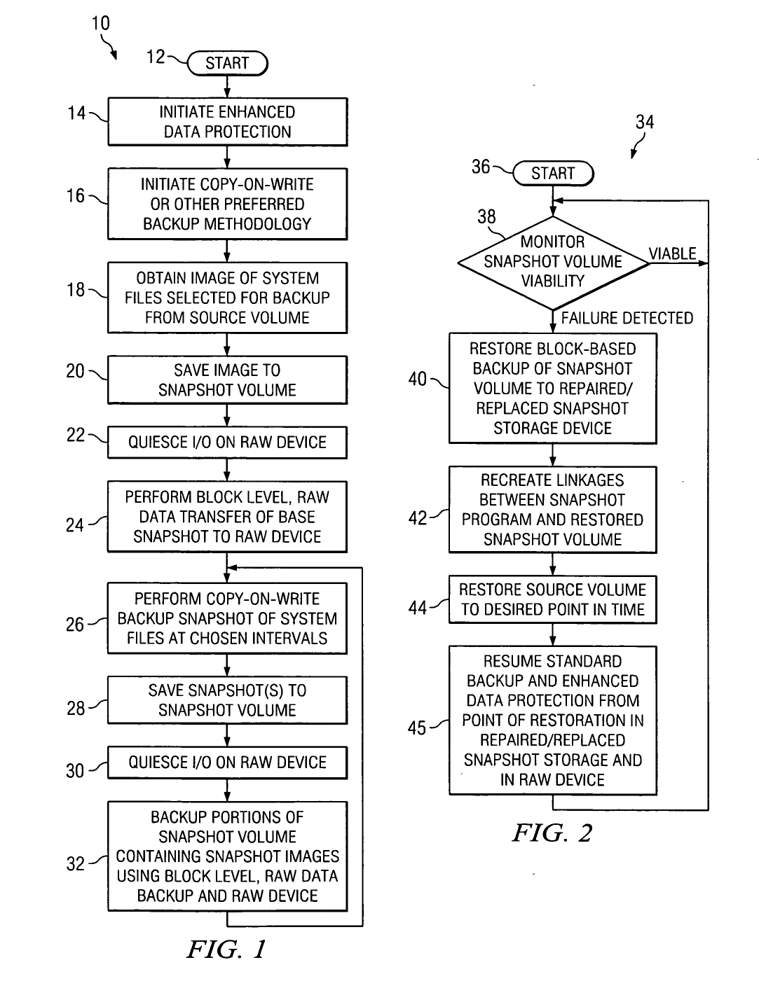

Preferred embodiments and their advantages are best understood by reference to FIGS. 1 through 3, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

In many existing data centers, data may be backed up by taking a copy-on-write snapshot at defined or chosen intervals or in response to one or more monitored events. By taking data snapshots in such instances, a point-in-time image may be captured at that moment providing an administrator with an exact copy of volume data at the point the snapshot was taken.

Preferably, snapshot images are saved to a storage system such as one or more hard drive devices, tape drives, optical drives, storage area networks, etc. One problem with saving snapshots images to storage, however, is that all snapshots are typically collocated on a storage device which creates the risk that if the storage device fails, all snapshot images may be lost.

To overcome these and other shortcomings, teachings of the present disclosure, in general, describe technologies that grant data center administrators the ability to backup and restore existing copy-on-write and/or point-in-time snapshot volumes. In addition, with processes defining an ability to restore a failing or failed snapshot volume, teachings of the present disclosure also grant administrators the capability to further restore a system volume, with granularity, to substantially any point in time.

In an exemplary embodiment, teachings of the present disclosure address limitations in current technology by backing up all data blocks on a snapshot volume that contains snapshot images. Preferably, (remove perferrably) all data is backed up at a block level using a raw data enabled device, not via an operating system file system.

In one aspect, by backing up the entire data at the block data level, all data on a volume may be easily copied. In accordance with teachings of the present disclosure, the data blocks backed up preferably include all point-in-time images. According to teachings of the present disclosure, if a snapshot volume is lost due to one or more disasters or other storage failures, the volume may be recovered by restoring all block-based backups to a repaired or replaced snapshot volume storage device. Once a snapshot volume has been restored, an administrator is able to restore a system, base or source volume to any point-in-time image from the restored snapshot volume, should such restoration needs arise, e.g., from a failure of the base or source volume storage device.

Upon restoring a snapshot volume, linkages between the snapshot backup program and the restored snapshot volume must be reestablished, recreated or linked back together. In one aspect, this may be necessary because typical snapshot programs generally keep track of all point-in-time images that reside on the snapshot volume, and, if a snapshot volume is lost, linkages between the snapshot program and snapshot volume are typically also lost. Consequently, if a snapshot volume is lost and subsequently restored, the point-in-time images on the snapshot volume generally must be linked back to the snapshot backup utility or program.

In addition, both as added functionality to the teachings above as well as to the benefit of data center administration, this concept can be extended forward. Specifically, once a base or source volume is backed up, it may only be necessary to backup future snapshot cache files that reference the original volume. In one aspect, this may further optimize the backup process by reducing, for example, disk, tape, or other storage management costs. Any individual snapshot may be restored to disk, allowing full volume and/or file recovery.

Referring now to FIG. 1, a flow diagram depicting one embodiment of an exemplary method for enhanced data protection using raw device backup of copy-on-write snapshots according to teachings of the present disclosure is shown. Exemplary method 10 of FIG. 1 preferably begins at 12 before proceeding to 14.

At 14 of exemplary method 10, one or more enhanced data protection software applications incorporating teachings of the present disclosure are preferably activated or initiated. Operations preferably performed by one or more software applications operable to implement one or more portions of the enhanced data protection teachings of the present disclosure will be discussed in greater detail below and with respect to FIG. 2. After operations preferably performed at 14, exemplary method 10 preferably proceeds to 16.

A user preferred backup application, program, utility or methodology is preferably initiated at 16. According to an exemplary embodiment of teachings of the present disclosure, the backup methodology preferably initiated at 16 is a copy-on-write, point-in-time or other snapshot-based backup utility.

In general, a snapshot-based backup utility may be defined as backup utility operable to obtain an image or copy of a defined collection of data created substantially instantly at the point in time of imaging or copying. Snapshot copies may be made substantially immediately within a disk subsystem, regardless of the size of the source or base volume.

Further, copy-on-write snapshots may be generally defined as logical copies of data created by saving original, base or source data to a snapshot index whenever data in an original, or source base volume is updated. Essentially, the copy-on-write snapshot process creates an empty snapshot index holding the original values that later change in the base volume after the time of snapshot creation. As such, with copy-on-write snapshots, two writes occur when original, base or source data gets updated. The original, base or source value is first written in the snapshot index and the change to the base volume is then made.

Snapshot creation typically takes only as long as is needed to build a snapshot index. It is recommended that the source or base volume of data be quiesced or quieted during snapshot creation to enable capture of a stable image of the moment in time. A snapshot may be viewed by combining base volume data with the snapshot index containing original data changed in the base volume. There are various implementations of snapshot data backup and copy-on-write snapshot data backup that may be utilized with teachings of the present disclosure.

Following initiation of a preferred snapshot backup utility or application at 16, exemplary method 10 preferably proceeds to 18. At 18, normal processing of the preferred backup utility or application is preferably permitted and/or performed. As described in FIG. 1, one or more images of selected system files or other information from a base or source data volume may be obtained in accordance with the preferred backup application during normal processing operations. Once a snapshot image of one or more selected files or other data has been obtained at 18, method 10 preferably proceeds to 20. At 20, the one or more snapshot images are preferably stored in a snapshot volume. In a preferred embodiment and in accordance with data backup best practices, one or more separate data storage devices are preferably employed for storing snapshot images and/or snapshot volume. In this manner, should the base or source volume data storage device fail, the snapshot volume and its associated data will in most instances remain intact and available for base or source volume rebuilding purposes. Following storage of a base snapshot image to a snapshot volume at 20, exemplary method 10 preferably proceeds to 22. At 22, exemplary method 10 preferably provides for the quieting or quiescing of input/output (I/O) operations on one or more raw devices operably coupled to the snapshot volume and/or the original, base or source volume data storage devices.

In one aspect, raw devices may be defined as character oriented disk device files as opposed to block oriented disk files. Further, raw devices may be defined as unformatted disks or disk partitions that applications can use to bypass normal operating system procedures for reading and writing data to and from the disk. As such, by using raw devices, the file system of an operating system running on an information handling system may be bypassed allowing I/O operations to be efficiently performed.

According to teachings of the present disclosure, once I/O operations on the raw device have been quiesced at 22, exemplary method 10 preferably proceeds to 24. At 24, the original, base or source volume snapshot obtained 18 and stored in a snapshot volume at 20 is preferably backed up to a raw device using block level, raw data transfer. In one embodiment of teachings of the present disclosure, block level data backup may be described as data backup in which blocks of data, as opposed to character by character data movement, are placed into storage. As processed in accordance with teachings of the present disclosure, the blocks of data are preferably backed up as unprocessed or raw data.

Following the acquisition and storage of a base image of the source or base volume at 18 and 20, respectively, and/or following I/O quiesceing and block level backup of the base snapshot image at 22 and 24, respectively, exemplary method 10 preferably proceeds to 26. At 26, exemplary method 10 preferably performs one or more backup snapshots of all data at chosen intervals or in response to selected events in accordance with the normal operation of the preferred snapshot-based backup utility initiated at 16, e.g., copy-on-write, snapshots at defined time intervals, etc.

Following the acquisition of one or more backup snapshots at 26, exemplary method 10 preferably proceeds to 28 where the backup snapshot images are stored in a snapshot volume. Similar to the data snapshots taken at 18 and stored at 20, backup snapshots obtained at 22 are preferably stored in a snapshot volume data storage device maintained separate and apart from the original, base or source data volume at least for purposes of data availability and in accordance with preferred data backup practices.

Following storage of the backup snapshots to a snapshot volume at 28, exemplary method 10 preferably proceeds to 30. At 30, exemplary method 10 preferably provides for the quieting or quiescing of input/output (I/O) operations on a snapshot volume backup raw device operably coupled to the snapshot volume and/or base volume data storage devices.

According to teachings of the present disclosure, once I/O operations on the raw device have been quiesced at 30, exemplary method 10 preferably proceeds to 32. At 32, one or more backup snapshot images are preferably transferred to the raw device using block level, raw data transfer.

At 32, teachings of the present disclosure provide for at least two differing methodologies for backing-up a snapshot volume. In one embodiment, method 10 at 32 may provide for the entire source volume, i.e., the base snapshot image and any copy-on-write snapshot images, to be backed-up to a RAW device at each instance the snapshot volume is backed-up. In an alternate embodiment, method 10 may provide for the base snapshot image to be backed-up to the RAW device at 24 and provide for only copy-on-write snapshots to be backed-up to the RAW device at 32. In addition, modifications to and/or combinations of these two methodologies may also be implemented in accordance with teachings of the present disclosure.

As illustrated in FIG. 1, exemplary method 10 preferably enters what may be described as a copy-on-write and raw device block level backup snapshot loop after completing a first run of operations at 32. Generally so long as the information handling system facilitating exemplary method 10 remains operational, operations preferably performed at 26, 28, 30 and 32 may facilitate the maintenance of recent or backup snapshots of a base or source data volume both in a snapshot volume and in a raw device snapshot backup volume. Various modifications may be made to exemplary method 10 without departing from the spirit and scope of teachings of the present disclosure.

Referring now to FIG. 2, a flow diagram depicting one embodiment of an exemplary method for restoring a failing or failed snapshot data volume according to teachings of the present disclosure is shown. Exemplary method 34 of FIG. 2, in one embodiment of teachings of the present disclosure, preferably operates substantially in conjunction with exemplary method 10. However, alternate implementations and cooperation between exemplary methods 10 and 34 may be effected without departing from the spirit and scope of teachings of the present disclosure.

After beginning at 36, exemplary method 34 preferably proceeds to 38. At 38, exemplary method 34 preferably provides for monitoring the viability of the one or more maintained snapshot volumes and associated data storage devices. Recall that one embodiment of a snapshot volume may be defined as the one or more snapshot volumes to which one or more backup snapshots are stored during the operation of exemplary method 10 at 20 and 28.

If at 38 it is determined that the one or more snapshots volume being monitored remain viable, exemplary method 34 preferably loops at 38 to continue monitoring the one or more snapshot volume data storage devices. A delay following a snapshot volume data storage device viability inquiry may be included such that snapshot volume viability is periodically checked as opposed to continuously monitored.

Alternatively, if at 38 it is determined that one or more monitored snapshot volume data storage devices has failed or may be described as failing according to one or more operational parameters, exemplary method 34 preferably proceeds to 40. At 40, exemplary method 34 preferably provides for initiation of a rebuild process for the failed or failing snapshot volume data storage device. As a part of the snapshot volume rebuild process preferably initiated at 40, exemplary method 34 preferably provides for the restoration of the snapshot volume to a repaired or replaced snapshot volume data storage device using the block data stored in the snapshot backup raw device.

Following the restoration of a snapshot volume via transfer of the snapshot backup block copied data from the raw device at 40, exemplary method 34 preferably proceeds to 42. At 42, linkages between the restored snapshot volume and the preferred snapshot-based backup application controlling snapshot backup operations on the base or source volume and the snapshot volume are re-connected. In at least one aspect, as described above, this recreation preferably enables linkages between the snapshot volume and the snapshot index to be reestablished.

Following restoration of the snapshot volume from the block data copied snapshot backup information at 40 and the recreation or reestablishment of linkages between the snapshot backup program and the restored snapshot volume at 42, exemplary method 34 preferably proceeds to 44. At 44, the source volume may be restored to any desired point in time image from the data available in the associated snapshot volume or a restored snapshot volume. At 45, exemplary method 30 provides for the resumption of normal or standard snapshot backup procedures, such as those typically managed by the preferred snapshot backup utility initiated at 16.

In one aspect of teachings of the present disclosure, normal or standard snapshot backup procedures may be continued from the point of restoration forward. In other words, the snapshot program need not capture an image of the restored system and then begin backing up snapshots in accordance with copy-on-write or other snapshot utility settings. Instead, the preferred snapshot utility may continue backing up data with snapshots triggered by copy-on-write or other triggers. In this manner, time, effort and data storage space may be conserved as the snapshot backup utility may proceed as if a failure had not occurred. Following the operations preferably performed at 44, exemplary method 34 preferably returns to 38 where the restored and other snapshot volumes may be monitored for their viability.

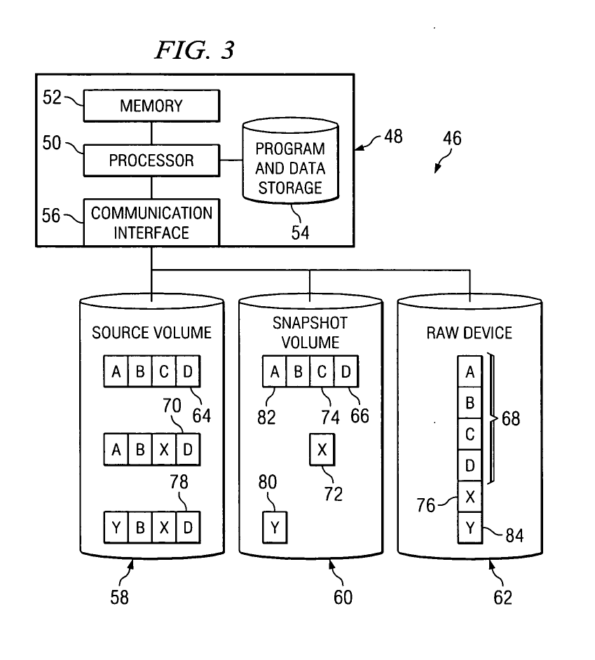

Referring now to FIG. 3, a schematic diagram depicting an exemplary embodiment of a system operable to perform raw device backup of copy-on-write snapshot images according to teachings of the present disclosure is shown. Exemplary system 46 is one embodiment of an system operable to effect one or more aspects of teachings of the present disclosure. In addition to server-based systems, teachings of the present disclosure may be implemented with such other instrumentalities as intelligent switches and virtualization devices.

As illustrated in FIG. 3, exemplary system 46 may include information handling system 48. Information handling system 48 preferably includes one or more microprocessors 50 or similarly enabled devices. Operably coupled to processor 50 is memory 52. Processor 50 and memory 52 preferably cooperate to execute and store, respectively, one or more instructions of a program of instructions. For example, memory 52 and processor 50 may cooperate to effect a preferred copy-on-write or other snapshot-base backup application or utility available in program and data storage device 54. Other data and/or information may also be maintained in storage 54.

In addition, information handling system 48 may also include one or more communication interfaces 56. Communication interface 56 preferably enables information handling system 48 to communicate with one or more internal or external data handling components. For example, communication interface 56 may enable information handling system 48 to communicate with one or more external storage devices 58, 60 and 62, a storage area network, and internal or external optical drive, as well as numerous other information handling system components.

As illustrated in FIG. 3, data storage devices 58, 60 and 62 may be external to information handling system 48. However, in an alternate embodiment, storage devices 58, 60 and/or 62 may be implemented internal to information handling system 48. Storage devices 58, 60 and 62 may include, without limitation, one or more hard drive devices, optical drives, magnetic drives, tape drives, storage area network devices, etc.

Also illustrated in FIG. 3 is one example of an implementation of the teachings of the present disclosure. It should be noted that while discussion herein makes primary reference to copy-on-write snapshot-based backup technology, teachings of the present disclosure may benefit myriad other backup technologies and, as such, such technologies are contemplated within the spirit and scope of the present disclosure.

Referring now to FIGS. 1 through 3, base or source volume 58, snapshot volume 60 and raw device 62 may be leveraged in conjunction with the teachings of exemplary methods 10 and 34 to provide enhanced data protection. Following the initiation of enhanced data protection and a preferred snapshot backup utility at 14 and 16 of exemplary method 10, base data 64 written to source volume 58 is preferably backed up in accordance with the preferred backup utility operated by information handling system 48. In this manner, an image of base data 64 is taken per the capabilities of the preferred backup utility and the image is stored as base snapshot data image 66 on snapshot volume 60, as described above in exemplary method 10 at 18 and 20, respectively.

Following the capture of an image of data 64 and storage of the base snapshot image data 66, a block copy process may be initiated to place a block level copy 68 of base snapshot data image 66 on raw data-enabled device 62. Preferably, prior to block level, raw data copying of base snapshot data image 66, all I/O on raw device 62 will be quiesced.

Having created base, source or original data 64, exemplary method 10 preferably enters a copy-on-write or other triggered snapshot backup mode at 26, as described above. Also as described above, exemplary method 34, after establishing snapshot volume 60, preferably enters a snapshot monitoring mode at 38.

Base data 70 reflects a change in original data 64. In accordance with exemplary method 10, a copy-on-write event has occurred which results in the preferred copy-on-write snapshot backup utility, at 26, performing a snapshot of the changes to data 64. Following acquisition of the snapshot of the changes to data 64, exemplary method 10 provides for storage of the data change as backup snapshot image 72 on snapshot volume 60.

As described above, copy-on-write snapshot utilities typically maintain an index or other linkage reference (not expressly shown) which tracks and/or associates stored base or source data images with copy-on-write or other subsequently stored snapshot images. Accordingly, in conjunction with placing data change backup snapshot image 72 on snapshot volume 60, a pointer or other reference is noted indicating that changed data backup snapshot image 72 replaces, supplements or otherwise affects data subset 74 of base snapshot image 66. As mentioned above, such linkages or indices enable the copy-on-write program to reconstruct a source or base volume upon failure. Recall that a variety of triggers may be utilized with a preferred snapshot backup utility including, without limitation, data alterations, new data being written, or one or more other triggers.

As with base, source or original data snapshot image 66, changed data backup snapshot image 72 is preferably copied to raw device 62 using a block level, raw data transfer mechanism at 32 of exemplary method 10 creating block data 76. Similar operations preferably occur in response to base data 78 resulting in changed data backup snapshot image 80 associated with base data subset 82 and raw device block level data copy 84.

In an alternate to backing-up a single copy of base snapshot image 66 and any subsequent copy-on-write snapshot images, such as copy-on-write snapshot images 72 and 80, as mentioned above, teachings of the present disclosure may also provide for back-up of entire snapshot volume 60 at regular intervals, such as in response to placement of copy-on-write snapshot 72 or 80 thereon. In such an embodiment, following the creation of snapshot image 72, base snapshot image 66 and copy-on-write snapshot image 72 would be added to RAW device 62 where a back-up copy of base image 66 preferably already exists. Continuing, in response to the creation of copy-on-write snapshot image 80, such an embodiment would preferably provide for base snapshot image 66 as well as copy-on-write snapshot images 72 and 80 to be backed-up to RAW device 62 thereby creating on RAW device 62 a back-up copy of base snapshot image 66, a second back-up copy of base snapshot image 66 plus copy-on-write snapshot image 72 and a third back-up copy of base snapshot image 66 plus copy-on-write snapshot images 72 and 80.

Prior to teachings of the present disclosure, if snapshot volume 60 were to fail, all data maintained thereon would be lost and source volume 58 would be without a backup copy. With the benefit of teachings of the present disclosure, a failed snapshot volume may be restored or replaced from the block-level, raw data maintained on raw device 62.

As described above with respect to exemplary method 34, a failed or failing snapshot volume may be restored from the block-level, raw data maintained on raw device 62. Upon detecting a failed or failing snapshot volume, and upon the replacement of any necessary hardware, data from raw device 62 may be placed on the replacement or repaired snapshot volume such that all relevant data is restored. In addition to returning all relevant data to the replaced or restored snapshot volume, linkages base between the base or source data images, such as backup snapshot 66, and copy-on-write or other subsequent snapshots, such as changed data backup snapshot images 72 and 80, are restored. In this manner, snapshot volume 60 may be restored to the point at which the failure occurred. In an alternate or enhanced implementation, a snapshot volume may restored to virtually any point in time, such as to the point of change in base or source snapshot image occurring in backup snapshot image 72, prior to the change reflected at changed data backup snapshot image 80. From this, the preferred snapshot backup utility need not restart the backup process from the point of capturing a base or source snapshot, but instead may proceed from the chosen restoration point, which, in some instances, permits the snapshot backup utility to continue as if there had never been a snapshot volume failure.

Although the disclosed embodiments have been described in detail, it should be understood that various changes, substitutions and alterations can be made to the embodiments without departing from their spirit and scope.

What is claimed is:

1. A method for providing enhanced data protection, comprising:
obtaining a first image of a data file;
storing the first image of the data file in a first data storage area;
storing data indicative of the first image in a second data storage area;
obtaining one or more images of the data file subsequent to the first image in response to one or more monitored events;
storing one or more of the subsequent images of the data file in the first data storage area; and
storing data indicative of one or more of the subsequent images of the data file in a second data storage area.

2. The method of claim 1, further comprising recreating the first image from the second data storage area in response to a first image access failure in the first data storage area.

3. The method of claim 2, further comprising recreating one or more subsequent images from the second data storage area in response to a subsequent image access failure in the first data storage area.

4. The method of claim 3, further comprising reinitiating obtaining one or more subsequent images of the data file in response to one or more monitored events after recreation of the data file from the second data storage area wherein the one or more subsequent images are obtained beginning at a recreation point associated with data file recreation.

5. The method of claim 1, further comprising obtaining a first image of an entire data volume associated with the data file.

6. The method of claim 1, further comprising obtaining the first image and one or more subsequent images using a copy-on-write snapshot data storage solution.

7. The method of claim 1, further comprising obtaining the first image of the data file such that the data indicative of the first image stored in the second data storage area is raw data representative of the first data file image.

8. The method of claim 1, further comprising storing the first image and one or more subsequent images to the second data storage area where the second data storage area is included on a raw data-enabled data storage device.

9. The method of claim 1, further comprising storing the first image and one or more subsequent images in the second data storage area where the second data storage area includes a sequential storage device.

10. Software for providing enhanced data back-up, the software embodied in computer readable media and when executed operable to direct an information handling system to:
copy, in an unprocessed data format, a first back-up image of a data array residing in a first data storage area, the back-up image residing in a second data storage area;
store the copied first back-up image in a third data storage area as unprocessed data;
copy, in an unprocessed data format, one or more subsequent back-up images created from the data array residing in the first data storage area, the subsequent back-up images residing in the second data storage area; and
store the one or more subsequent back-up images as unprocessed data in the third data storage area.

11. The software of claim 10, further operable to direct an information handling system to restore the data array of the first data storage area in response to a first data storage area failure.

12. The software of claim 10, further operable to direct an information handling system to reproduce the unprocessed data copies of the first back-up image and the one or more subsequent back-up images in a first data storage area replacement data storage area.

13. The software of claim 12, further operable to direct an information handling system to resume copying and storing subsequent back-up images from a restoration point associated with the reproduction of the data of the first data storage area in the replacement data storage area.

14. The software of claim 10, further operable to direct an information handling system to:
copy, in an unprocessed data format, a first back-up image of a data array residing in a first data storage area, the back-up image residing in the second data storage area and the data array representing an entire data volume of the first data storage area; and
store the copied first back-up image representing the entire data volume of the first data storage area in the third data storage area as unprocessed data.

15. The software of claim 14, further operable to direct an information handling system to:
copy, in an unprocessed data format, one or more subsequent back-up images created from the data array residing in the first data storage area, the subsequent back-up images residing in the second data storage area and reflecting changes made to one or more components of the entire data volume of the first data storage area; and
store the one or more subsequent back-up images reflecting changes made to one or more components of the entire data volume of the first data storage area as unprocessed data in the third data storage area.

16. The software of claim 10, further operable to direct an information handling system to create the first back-up image and the one or more subsequent back-up images using copy-on-write snapshot technology.

17. An information handling system providing enhanced data back-up and protection, comprising:
memory;
at least one processor operably coupled to the memory; and
a program of instructions storable in the memory and executable in the processor, the program of instructions operable to perform copy-on-write snapshots of data residing on a first data storage device, store the snapshots on a snapshot data storage device and copy the snapshots as raw data to a raw data storage device.

18. The information handling system of claim 17, further comprising the program of instructions operable to perform a first snapshot of an entire data volume residing on the first data storage device and perform subsequent snapshots of one or more portions of the entire data volume in response to one or more monitored events concerning the first data storage device.

19. The information handling system of claim 17, further comprising the program of instructions operable to restore contents of the snapshot data storage device in response to a snapshot data storage device access failure by reproducing the snapshots on a fail-over snapshot data storage device from the raw data snapshots stored on the raw data storage device.

20. The information handling system of claim 19, further comprising the program of instructions operable to restore contents of the first data storage device in response to a first data storage device access failure by reproducing the first data storage device data on a fail-over data storage device using the snapshots on the fail-over snapshot data storage device.
